(19) United States
(12) Patent Application Publication
(10) Pub. No.: US 2014/0218403 A1
(43) Pub. Date: Aug. 7, 2014

(54) Apparatus and Method to Display Images Protected From Capture

(71) Applicant: KeepSafe Software, Inc., San Francisco, CA (US)

(72) Inventors: Zouhair Belkoura, San Francisco, CA (US); Philipp Berner, San Francisco, CA (US)

(73) Assignee: KeepSafe Software, Inc., San Francisco, CA (US)

(21) Appl. No.: 14/198,526

(22) Filed: Mar. 5, 2014

Related U.S. Application Data
(63) Continuation-in-part of application No. 14/167,946, filed on Jan. 29, 2014.
(60) Provisional application No. 61/759,973, filed on Feb. 1, 2013.

(51) Int. Cl. G06T 11/60

(52) U.S. Cl. CPC G06T 11/60
USPC 345/635

(57) ABSTRACT

A computer implemented method includes receiving a request to display text. The text is displayed as a succession of subimages such that a human eye perceives the subimages as the text and a photograph or screen shot at any point in time captures a subset of the subimages representing an incomplete version of the text.

### CROSS-REFERENCE TO RELATED APPLICATION

This application is a continuation-in-part of U.S. patent application Ser. No. 14/167,946, filed Jan. 29, 2014, the contents of which are incorporated herein by reference.

### FIELD OF THE INVENTION

This invention relates generally to the display of images on digital devices. More particularly, this invention relates to techniques to transform and display an image on a screen of a digital device such that the image cannot be captured with a screenshot or a photograph.

### BACKGROUND OF THE INVENTION

An individual is often interested in sharing an image, but maintaining control of the image. Sharing a self-destructing image (e.g., the image self-destructs after three seconds) is one way of controlling the image. However, such images are susceptible to preservation through a screenshot or a photograph taken of the screen while the self-destructing image is displayed.

In view of the foregoing, it would be desirable to provide improved techniques for controlling access to an image.

### SUMMARY OF THE INVENTION

A computer implemented method includes receiving a request to display text. The text is displayed as a succession of subimages such that a human eye perceives the subimages as the text and a photograph or screen shot at any point in time captures a sub-set of the subimages representing an incomplete version of the text.

A non-transitory computer readable storage medium includes instructions executed by a processor to divide text into subimages. The subimages are displayed in succession such that a human eye perceives the subimages as the text and a photograph or screen shot at any point in time captures a sub-set of the subimages representing an incomplete version of the text.

### BRIEF DESCRIPTION OF THE DRAWINGS

The invention is more fully appreciated in connection with the following detailed description taken in conjunction with the accompanying drawings, in which:

FIGS. 1A-1C show a high-frequency sequential display of subimages in accordance with an embodiment of the invention.

FIGS. 2A-2D show subimages in a checkerboard pattern utilized in accordance with an embodiment of the invention.

FIGS. 3A-3D show subimages of different sizes utilized in accordance with an embodiment of the invention.

FIG. 4 illustrates processing operations associated with an embodiment of the invention.

FIG. 5 illustrates a device configured in accordance with an embodiment of the invention.

Like reference numerals refer to corresponding parts throughout the several views of the drawings.

### DETAILED DESCRIPTION

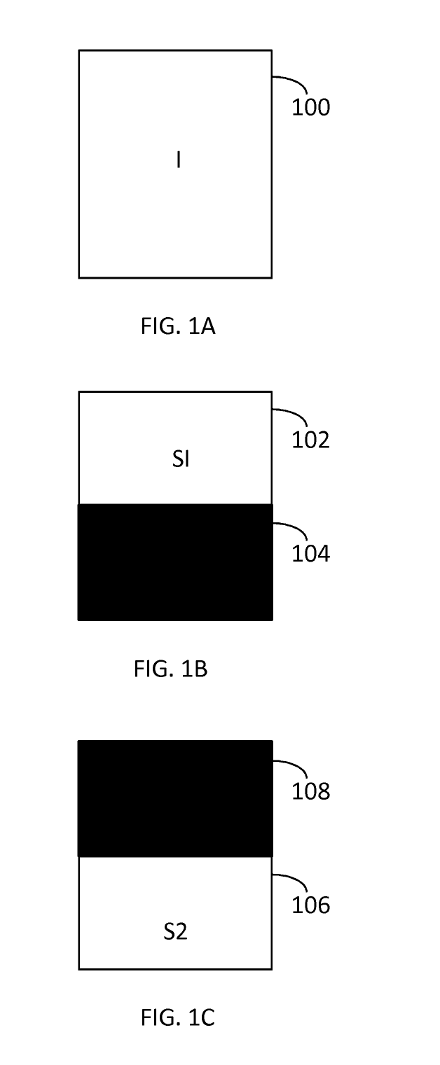

Take an original still image I with length x and width y. Such an image is shown as image 100 in FIG. 1A. This image I is used to produce a number of subimages S₁,S₂, . . . , Sₙ, such that a high-frequency sequential display of subimages S₁, . . . , Sₙ will be perceived by the human eye as the original image I. For example, FIG. 1B shows subimage S1 102 adjacent to a blank space 104, while FIG. 1C shows subimage S2 106 adjacent to a blank space 108.

There are numerous ways in which the subimages S₁, . . . , Sₙ can be generated. Any transform will be successful if a high-frequency sequential display of subimages S₁, . . . , Sₙ is perceived by the human eye as the original I.

For example, in a simple case, I is divided in two separate half images, S₁, S₂, where S₁ contains the upper half of I and S₂ the lower half of I. This is illustrated in FIGS. 1B and 1C.

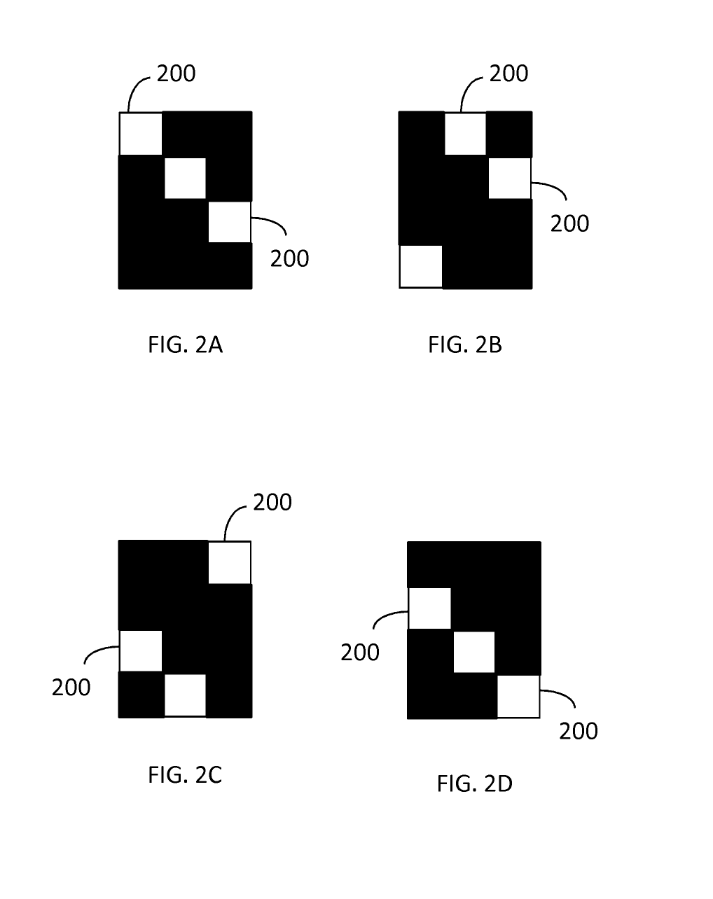

Note that there is no requirement for the divided images S₁, . . . , Sₙ to be disjunct with respect to the portion of I that they display, meaning that there might be some overlap as shown in FIGS. 2A-2D. For example, FIG. 2A shows subimages 200 in one configuration, while FIGS. 2B-2D shows subimages 200 in different configurations.

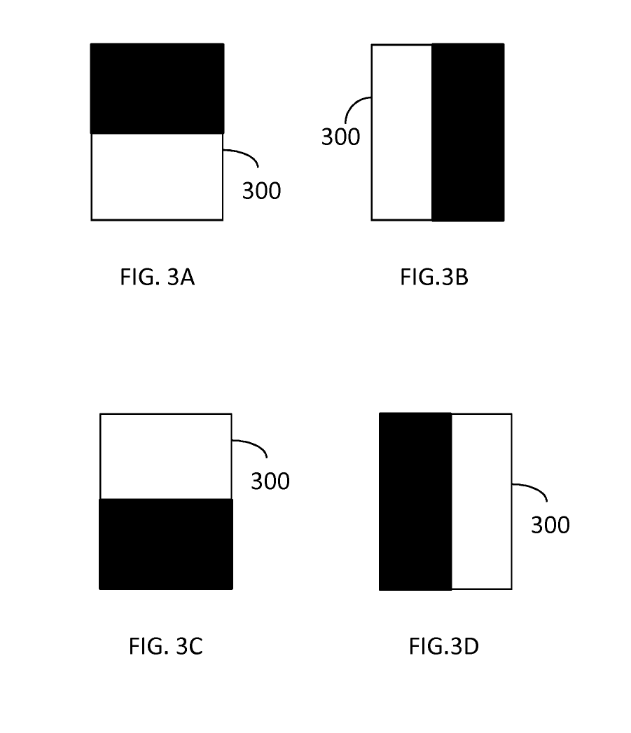

Similarly, there is no requirement for the subimages to be created by selecting rectangular or otherwise regular surface shapes although this might prove the most practical. For example, FIG. 3A illustrates a subimage 300 with one configuration, while FIGS. 3B illustrates a subimage 300 with another configuration.

Finally, while the example drawings depict a division in the spatial dimension of the original image I, any division can be applied, for example in the color space dimensions or along spatial frequency dimensions (e.g., as computed by Discrete Fourier Transforms), so long as the sequential display of subimages is perceived by the human eye as the original.

The complete set of subimages S₁, . . . , Sₙ is displayed in rapid succession, where the display frequency is chosen high enough to overcome the psychovisual barrier, after which the human eye perceives the sequential display as a single still original image. Effectively, the set of subimages is treated as a very short video-clip in which the individual images are S₁, . . . , Sₙ. The display algorithm indefinitely loops this video (unless the image is scheduled for self-destruction).

The combination of eye and brain can process 10-12 individual images per second, on average. Specific perceptive limits are highly input and signal dependent, since it is known that the eye is more sensitive to some short dark flickers or fast intense luminance bursts. Variations in high spatial frequency are more easily perceived by the human eye than low spatial variations.

Traditionally, motion pictures have been captured at a frame rate of 24 frames per second (fps), each about 42 ms in duration. Fast dark flicker can be perceived at 16 ms, so modern television sets strive to reduce the frame rate to 60-100 Hz, showing individual pictures for a duration of 10-16 ms. Similarly, cinema projections usually display a single frame three times consecutively, effectively increasing the frame rate to 72 fps and thus effectively reducing the length of dark flicker.

In the context of screenshot proofed image display, it must be ensured that single images Sᵢ are displayed very briefly to fool the eye as described above. The infinite video loop S₁, . . . , Sₙ should therefore be displayed with a frequency of at least 60 Hz, since that is the threshold to perceive dark flicker. Increase in frequency is beneficial.

To minimize any flickering effect that the human eye might notice, the subimages may be displayed out of order. In addition, as long as the complete set of images is displayed in a fast enough succession, some of the subimages may be displayed more frequently than others.

The flicker-free perception of the subimage sequence as a still image depends on the algorithm chosen to generate these images. As a consequence, the display algorithm that determines which order and with which individual frequency these subimages need to be displayed is matched to the particular transformation that was chosen to generate the subimages Sᵢ.

A technical description of a possible implementation is provided as an example. While the description above outlines the general method and therefore a multitude of implementation options, this section focuses on a particular choice of parameters. Consider a Smartphone application. The application is a piece of software capable of taking images using the Smartphone camera and displaying captured images in a screenshot proof way by implementing the disclosed technology.

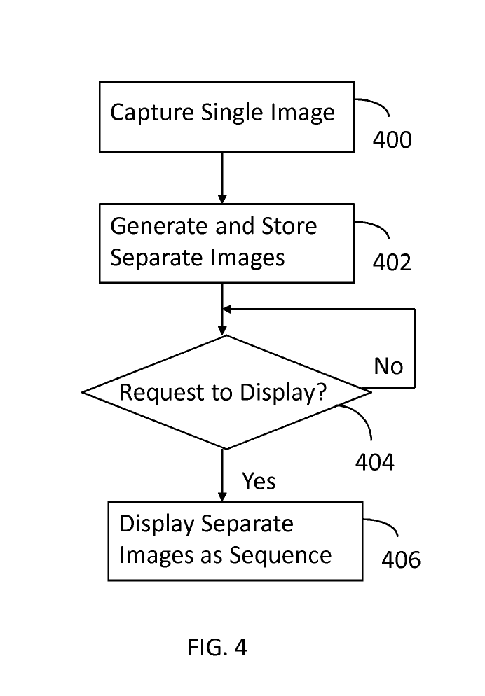

FIG. 4 illustrates processing operations associated with an embodiment of the invention. Initially, an image is captured 400. Let image I be a still image captured through the Smartphone camera by the application. The application generates and stores separate images 402. For example, the application transforms I and generates four separate images S₁,S₂,S₃,S₄. S₁ and S₂ contain the upper and lower half of I, as shown in FIGS. 3A and 3C, whereas S₃ and S₄ contain the left and right half of I respectively, as shown in FIGS. 3B and 3D. The application then waits for a request for a display of the image 404. In response to a request for display of the image, the image is displayed as a sequence of separate images 406. In this example, the application stores the set of images S={S1, . . . , S4} in its application storage. The application is programmed to display the set of images as a sequence. It loads the set S from storage and starts displaying the separate images in an infinite loop. In this example, S is made up of subimages S₁,S₂,S₃,S₄. The application displays a rapid succession of these subimages, changing the displayed subimage as frequently as the display hardware allows. In this example, the screen displays the sequence S₁,S₂,S₃,S₄,S₁,S₂,S₃,S₄, . . . The human eye sees a rapid superposition of this sequence and perceives the original image I because of the psychovisual limitations of perception.

At any time, a photograph of the screen display can be taken either by use of an external camera or by making use of device specific screen capture software. At the time of capture, only one of S₁, . . . , S₄ is actually displayed on the screen. Any single image captured from the device therefore has only partial information Sᵢ and never the full image I. Because the full image I cannot be captured by taking a photograph of the screen, this application has successfully implemented a screenshot-proof still image display.

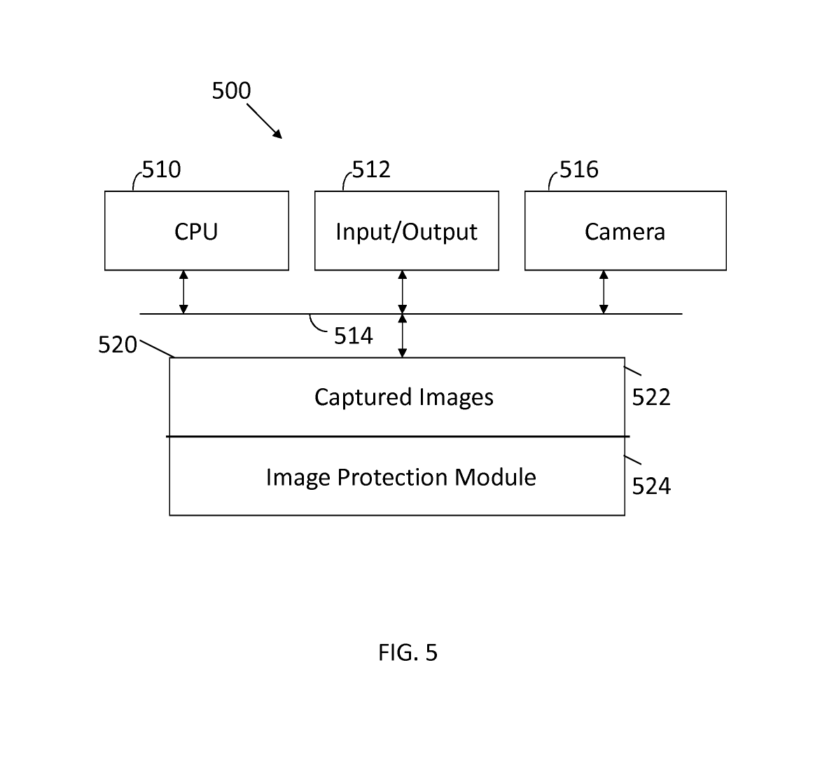

FIG. 5 illustrates a device 500 configured in accordance with an embodiment of the invention. The device 500 includes standard components, such as a central processing unit 510 and input/output devices 512 connected via a bus 514. The input/output devices 512 may include a touch display, keyboard, mouse and the like. In one embodiment, such as in the case of a mobile device, a camera 516 (e.g., a charge coupled device) is connected to the bus 514. A memory 520 is also connected to the bus 514. The memory 520 stores captured images 522, which are displayed by the image protection module 524. The image protection module 524 implements the operations of FIG. 4. Thus, the captured images 522 may represent an original image and/or an original image after it has been divided into subimages. The device 500 may be a mobile device, Smartphone, Tablet, set-top box, game console, wearable device, personal computer and the like.

In sum, the disclosed technology takes a still image and divides it into two or more subimages. The division into subimages may be spatial or otherwise, such that a superposition or other combination of the subimages reproduces the original image. The subimages are arranged to be displayed one after another in a loop. Each subimage is displayed only a fraction of a second. If single images are displayed in rapid succession, the human brain is incapable of discerning each individual image. In contrast, a sequence of subimages that are incomplete versions of the original image will be seen as the single, original still image. Screenshot technology or a photograph however only captures the information that is momentarily displayed on a screen. As a result, any time a screenshot is captured or a photograph is taken, the captured image will only display the subimage that was visible on the screen at that instance.

The “image” may be text or other content in electronic form. For example, individual characters in a sequence of text may be divided into subimages that are displayed in rapid succession. Alternately, the subimages may be individual characters that are displayed in rapid succession. Viewed in rapid succession, single subsequences that are incomplete versions of the original text display will be seen as the original text. Screenshot technology or a photogram only captures the information that is momentarily displayed on a screen. As a result, a screen shot or photograph only captures a subsequence of characters that are visible at that instance, which is an incomplete version of the text.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A non-transitory computer readable storage medium, comprising instructions executed by a processor to:
divide text into subimages; and
display the subimages in succession such that a human eye perceives the subimages as the text and a photograph or screen shot at any point in time captures a subset of the subimages representing an incomplete version of the text.

2. The non-transitory computer readable storage medium of claim 1 wherein the instructions to display the subimages display the subimages with a frequency of at least 60 Hz.

3. The non-transitory computer readable storage medium of claim 1 wherein the instructions to display the subimages display the subimages out of order.

4. The non-transitory computer readable storage medium of claim 1 wherein the instructions to display the subimages display some subimages more frequently than others.

5. The non-transitory computer readable storage medium of claim 1 wherein each subimage has the same shape.

6. The non-transitory computer readable storage medium of claim 1 wherein subimages have different shapes.

7. A computer implemented method, comprising:
receiving a request to display text; and
displaying subimages of the text in succession such that a human eye perceives the subimages as the text and a photograph or screen shot at any point in time captures a subset of the subimages representing an incomplete version of the text.

8. The method of claim 7 wherein displaying the subimages is performed at a frequency of at least 60 Hz.

9. The method of claim 7 wherein displaying the subimages includes displaying the subimages out of order.

10. The method of claim 7 wherein displaying the subimages includes displaying some subimages more frequently than others.

11. The method of claim 7 wherein displaying the subimages includes displaying subimages with the same shape.

12. The method of claim 7 wherein displaying the subimages includes displaying subimages with different shapes.
